(19) United States
(12) Patent Application Publication
(10) Pub. No.: US 2005/0040290 A1
(43) Pub. Date: Feb. 24, 2005

(54) Inflatable parachute for very low altitude jumping and method for delivering same to a person in need

(76) Inventor: Avraham Suhami, San Jose, CA (US)

Correspondence Address: AVRAHAM SUHAMI, APT. 307, 1496 ALMADEN EXPWY., SAN JOSE, CA, 95125, US

(21) Appl. No.: 10/641,266

(22) Filed: Aug. 15, 2003

(51) Int. Cl. B64D 17/00

(52) U.S. Cl. 244/146

(57) ABSTRACT

The invention consists in an inflatable ultralight parachute deployable before jumping, for jumping or releasing a load from any altitude, without experiencing unduly harm from the impact with the ground. It comprises at least one torus-shaped inflatable tube covered by a thin film substantially flat shroud whose buoyance lifts the parachute and when pulled down by the gravity of the attached body develops the braking force that decelerates its fall. The ultralight parachute is deployed either by the jumper if he has one, or by emergency helpers on the ground and subsequently lifted to the potential jumper. Optional accessories that enhance the braking force of the parachute and attenuate the impact of the attached body with the ground, include an aerodynamically shaped inversed skirt surrounding the torus-shaped tube, an electro-mechanical reel that upon activation shortest the distance between the jumper and the canopy and an air mattress that floats beneath the jumper's feet for reducing the impact of the fall when hitting the ground.

### BACKGROUND OF THE INVENTION

Parachutes serve to brake the free fall of objects or people in the atmosphere and reduce the falling speed to a level that makes the impact with the ground tolerable and does not cause undue harm. Parachutes are usually made from light-weight air-tight Zero Porosity fabrics and when opened, form a dome-like shape that holds a mass of air underneath. This mass of air when pulled down by the object attached to the fabric by suspension lines, exerts a force proportional to the squared velocity V² of the falling object and in opposite direction to the motion. The magnitude of this braking force is proportional to the surface (S) the downwards falling parachute presents to the stationary air within which it moves. During the initial free fall period, until such time that the canopy unfolds, the falling body accelerates and keeps increasing its velocity. After the canopy unfolds and is fully deployed, the parachute starts moving at the speed, the falling object is pulling it. This causes the pressure under the canopy to increase until the braking force F_{B}=kSV² equates the gravitational force (mg) pulling the object downwards, at which time the deceleration ends and the object continues to fall at the constant velocity it then reached. It has been found experimentally that the constant k≃0.1.

Thus to obtain the largest braking force, the surface projected by the canopy normal to the direction of motion has to be maximized, which is the strategy employed by most inventions in the previous art. Obviously during the time it takes until the canopy is fully deployed, the falling body continues to gain velocity and may hit the ground before the full braking force of the canopy is exerted and the falling velocity reduced.

U.S. patent application 20030094544 “Emergency parachute” of Yamada, Takeo describes an umbrella like parachute whose double-walled canopy may be inflated with gas emanating from a chamber in which the gas producing agent is ignited simultaneously with the leap of the jumper, in order to accelerate the deployment of the canopy and reduce the time until it starts braking the descent of the attached body.

U.S. Pat. No. 4,105,173 “Inflatable parachute for use as escape or sporting device.” issued to Bucker Henrique O. describes a parachute built with inflatable tubes that enables to deploy the parachute before jumping. U.S. Pat. No. 5,058,831 “Emergency escape unit” issued to S.Takahashi teaches a canopy inflated with helium for the purpose of deploying the parachute before jumping and adding buoyancy to it. However the design of both inventions is such that very large amounts of helium are needed to make the parachute float, what makes them impractical.

There is therefore a need for a lightweight parachute design that can be helium-inflated with a minimal amount of helium and floated before jumping, thus saving the time of deployment of the canopy and consequently enables to jump from a much lower altitude.

Several devices have been suggested in order to decelerate the descent of a falling body attached to a parachute. For example U.S. Pat. No. 6,224,019 “Parachute landing velocity attenuator” by Peterson, et al. describes a gas-powered landing velocity attenuator for reducing the final descent velocity of a parachutist or parachuted cargo. Immediately prior to impact, the gas source powers a device for drawing the load (either a parachutist or cargo) closer to the canopy of the parachute. In a first preferred embodiment, the load and the canopy are brought closer together by a single action piston and cable assembly powered by the gas source. A second embodiment uses an inflator assembly connected to an air bag or a braided tube to decrease the distance between the load and the parachute canopy. We judge that the speed of gas actuated devices not to be sufficiently effective in reducing the speed of descent as in principle they do not react fast enough and given their practical weight limitations they do not store enough energy to decelerate a 75 kg body appreciably. There is therefore a need for a better deceleration device.

### BRIEF SUMMARY OF THE INVENTION

It is the purpose of this invention to devise a parachute that enables jumping or releasing a load from any altitude, including but not limited to, very low altitudes, while keeping the impact with the ground at a tolerable level, similar to jumping from a moderately high wall. These goals are achieved mainly by deploying the canopy of an ultralight parachute, prior to jumping on the air. An additional purpose of the invention is to enable potential rescuers on the ground, to deploy, lift and direct an emergency parachute, to a person situated at an elevated floor and in need of the parachute.

The canopy of the parachute subject of the invention, consists of one or more circular or elliptical torus-shaped tubes, the top of which is covered by a substantially flat shroud, that upon experiencing the air pressure during its descent, slightly expands and takes the form of a shallow dome. In the following text a “torus-shaped tube” will mean a doughnut shaped tube closed on itself which may be elongated having a long and a short axes or circular when the two axes are equal, the term “lighter-than-air gas” shall mean helium, hydrogen when when combustibility is not feared or hot air. The torus-shaped tube is inflatable with lighter-than-air gas so that its buoyancy enables to slowly rise in the air, together with the shroud and the attached strings. Alternatively, a spherical balloon filled with lighter-than-air gas, may provide the needed buoyancy to lift the torus-shaped tube that may be inflated either with air or with lighter-than-air gas, the overlaying shroud and the jumper's harness suspended from the periphery of the torus-shaped tube.

Both the spherical balloon, the torus-shaped tube, the shroud and the strings are made of ultra-light polymers in order to reduce the total weight of the assembly, while keeping, their combined buoyancy larger than the weight, taking in account the needed strength to support a normal human body. The shroud which withstands the pressure exerted by the air, when moving downwards and takes the form of a flightly curved dome, may be reinforced by a matrix of fibers laminated or adhesively bonded to it. The ends of the fibers overhanging over the periphery of the shroud may be joined into groups of strands and used to sustain a harness that holds the jumper. The torus-shaped tube and the spherical balloon may be inflated, by the jumper just before he jumps to the airspace, suspended from the harness attached to a multiplicity of light-weight fiber strands overhanging from the periphery of the torus-shaped tube.

In one embodiment, when the torus-shaped tube is inflated by a lighter-than-air gas, its buoyancy lifts the canopy with its sagging shroud into the atmosphere and as soon as it is pulled down, the shroud expands upwards due to its elasticity and slightly protruding the top of the tube, takes the form of a shallow dome.

In another embodiment, which has a higher stability, but weighs more, the emergency parachute comprises two canopies positioned one above the other at a distance of the magnitude of the diameters of the canopies and interconnected by ultra-strong strings.

In an alternative embodiment which has a better buoyancy to weight ratio, a thinner torus-shaped tube, covered by the shroud, may be suspended from a spherical balloon both inflated by a lighter-than-air gas; their combined buoyancy enables both of them, the shroud, the support lines and the attached harness to slowly rise.

In still another embodiment the torus-shaped tube may be air inflated and the torus-shaped tube, the shroud and the harness sustained by a slightly larger spherical balloon inflated by lighter-than-air gas.

In all the embodiments, the torus-shaped tube(s) and the spherical balloon, may be inflated on the ground, and the emergency parachute lifted by its buoyancy to an altitude above the potential jumper in need of the parachute. The lifted parachute may then be “delivered” to the potential jumper in several ways, for example by “shooting” with an airgun, towards the place in close proximity to the jumper, a pellet from whose bottom unwinds a thin thread, attached at its other end to the harness of the parachute, thus enabling the jumper to get hold of the thread and pull the attached harness to him.

Pulling the torus-shaped tube by its strings downwards causes the shroud to expand upwards and exert a braking force proportional to its surface. The force needed to brake the gravitational fall of the jumper may be developed by one large surface canopy or by several, smaller canopies connected in series and together supporting the falling load.

An additional lift may be gained by attaching to the canopy's periphery an upwards and sideways pointing inflatable thin skirt, that provides additional aerodynamic lift to the canopy, by deflecting sideways the air flowing upwards, thus reducing the pressure at the upper surface of the canopy. However, the additional lift that may be gained by such a skirt has to be weighed against its additional weight that requires a larger buoyancy and therefore more helium.

To reduce the impact experienced by the jumper when he hits the ground, he may be provided with an air inflatable multi-layer mattress that serves as a shock absorber; the mattress may be attached to the harness with short cords, floating during the descent of the parachute at a distance immediately beneath the jumper's feet.

An additional accessory that may increase the braking force of the parachute is a high-torque, motorized electro-mechanical reel, inserted between the harness and the cords leading to a receptacle that connects the support lines leading to the canopy, similar in its construction to electrical fishing reels. The electrical reel is activated by the jumper immediately before jumping, and starts rewinding the cords connecting the harness to the receptacle, thus shortening the distance between them and in the process pulling the canopy down faster, thus increasing its dropping velocity and consequently its braking force. In principle the energy stored in the reel is translated with some efficiency reduction, into a braking force along the distance traveled by the jumper.

Any of the above described factors enables to increase the braking force of the parachute; their combination together with the elimination of the deployment time of the canopy, enables to jump from practically any altitude and hit the ground with a tolerable impact, without experiencing undue harm.

### BRIEF DESCRIPTION OF THE DRAWINGS

FIG. 1 illustrates a preferred embodiment of the light-weight parachute based on a helium filled spherical balloon sustaining an inflatable torus shaped annular tube supporting a strong ultralight large shroud, suspension cords that connect to a jumper harness and an optional shock absorbing inflatable mattress suspended from said harness.

FIG. 2 illustrates two thin shrouds covering two inflated torus shaped tubes, one circular and the second elliptical, strengthened by a triangular net of filaments laminated or adhesively bonded to its surface.

FIG. 3 illustrates an alternative embodiment of the light weight emergency parachute based on two inflatable torus-shaped circular or elliptical tubes connected in series, one beneath the other, each covered by a strong ultralight shroud.

FIG. 4 illustrates the forces acting on a twin canopy emergency parachute immediately after the jump.

FIG. 5 illustrates an inverted skirt attached to the periphery of the torus-shaped tube, designed to add additional lift to the shroud

FIG. 6 illustrates the first stage of a jump with the inflatable parachute, that consists in inflating the spherical balloon with helium.

FIG. 7 illustrates the jumper sitting on the sill of the window, from which it prepares to jump, inflating the air mattress that serves as a shock absorber.

FIG. 8 shows the jumper, immediately before jumping, standing on the sill of the frame of the window.

FIG. 9 shows the jumper after hitting the ground, his harness sustained by the canopy and the air inflated mattress beneath his feet, compressed from the impact with the ground.

FIG. 10 illustrates a braking device consisting of a reel, for quick rewinding the cords between the canopy and the jumper's harness.

FIG. 11 illustrates two modes of sending the parachute initially deployed at the ground, to the potential jumper waiting by a window at an elevated floor.

FIG. 12 illustrates several embodiments of a pellet that may be shot by a compressed gas gun that pulls a thin fiber string behind it.

FIG. 13 illustrates a possible method of attaching the thread protruding from the end of a projectile to the body of the compressed-gas gun.

### DETAILED DESCRIPTION OF THE PREFERRED EMBODIMENTS

As mentioned above, the main strategy employed in designing a parachute for low altitude jumping is to deploy the canopy before the jumper jumps into the air, thus allowing the canopy to exert its braking force immediately.

Table 1 shows the distance h₁ traveled by the jumper and the resultant falling speed V_{C} he attains by the end of the deployment time T_{C} of a regular parachute. It shows the importance of reducing or eliminating the deployment time T_{C} of the canopy, by pre-deploying it before the jump.

TABLE 1

| T_{C} (seconds) | h₁ (meters) | V_{C}(meter/sec) |
|---|---|---|
| 0.5 | 1.2 | 4.9 |
| 1 | 4.9 | 9.8 |
| 2 | 19.6 | 19.6 |

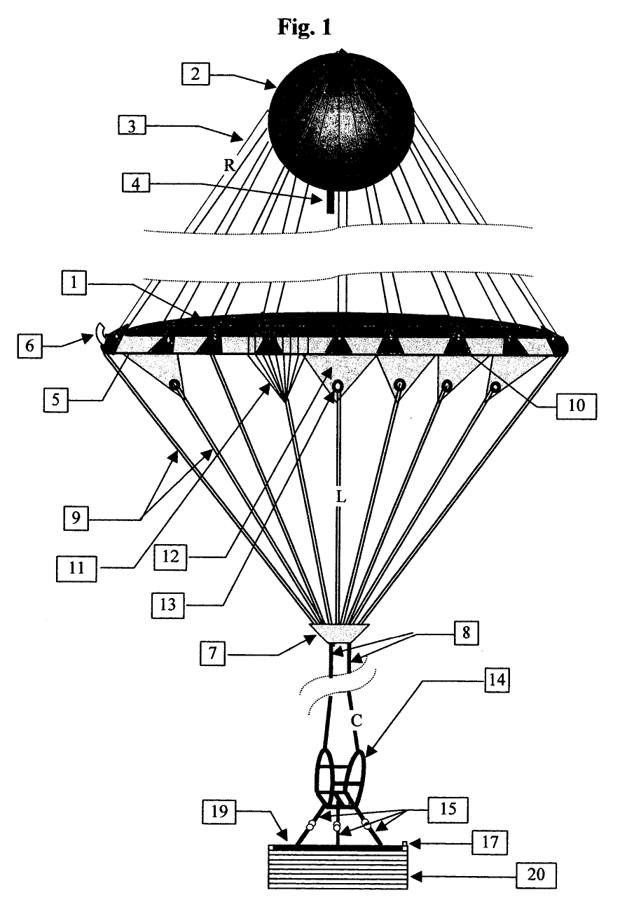

It has to be appreciated that a regular parachute has to develop a braking force, not only equal to the force of gravity exerted upon the jumper, but a much larger one, in order to decelerate the jumper that might have already reached a large falling velocity. This translates into a larger canopy and additional time for deceleration that limits the height from which it is safe to jump. FIG. 1 shows an embodiment of the invention's light-weight parachute, based on a helium filled spherical balloon 2 sustaining an inflatable torus-shaped annular tube 4 covered by a strong ultralight shroud 1. The drawing is not to scale and illustrates only the main components of the parachute. When the parachute is descending, the air pressure gives the shroud 1 a semi-flat, dome-like shape, due to its elasticity. The torus-shaped tube 5 can be inflated from a venting orifice attached to an elongated tube 6. When filled with helium, the buoyancy of the spherical balloon keeps the torus-shaped tube 5 afloat, together with the shroud 1 and the attached strings 9 ending in a receptacle 7. In this embodiment, the torus-shaped tube may have a very small diameter as its only function is to deploy the shroud when inflated; it may also be air inflated, and sustained by the buoyancy of the helium filled spherical balloon 2 to which it is attached by equal length strings 3 which provide an horizontal stability.

In an alternative embodiment, the parachute does not include a spherical helium filled balloon; the canopy may be kept afloat by the buoyancy of the torus-shaped tube 5 which in this case has to be larger and helium filled.

For equal buoyancy and from the point of view of helium availability, the thin torus-shaped annular tube suspended from a helium filled spherical balloon, is preferable to the thicker, helium filled, torus-shaped annular tube alone, as it requires less helium, although it complicates the structure and the deployment of the parachute.

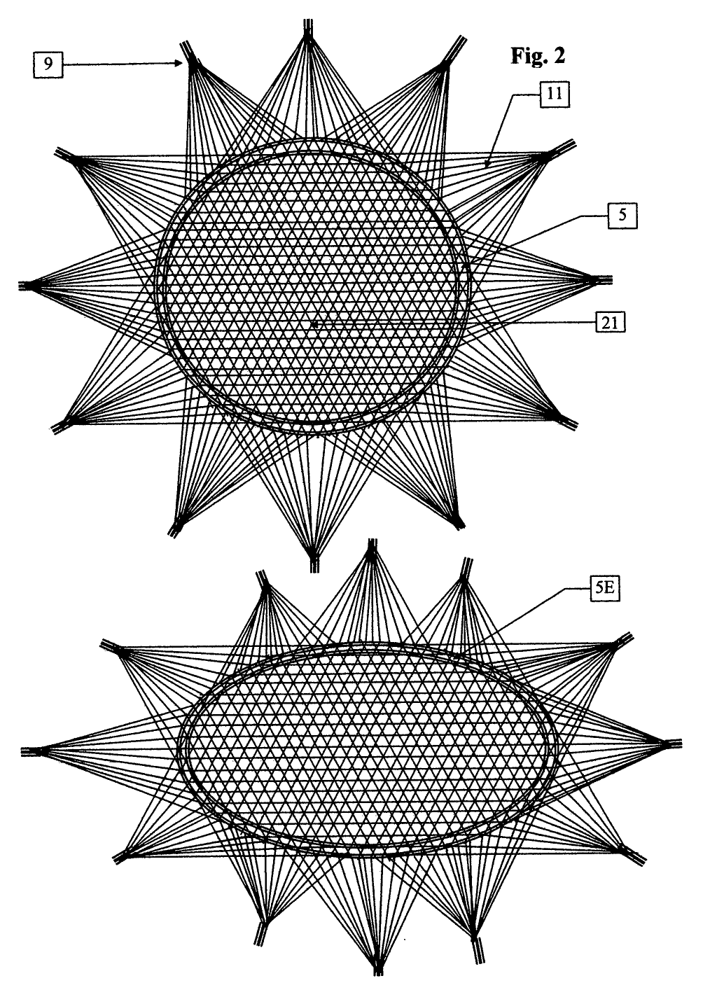

The spherical balloon sustaining the canopy of the parachute, the torus-shaped tube and the shroud are preferably made of ultralight PolyEthylene TerePhtalat (PETP) such as Dupont's Mylar or Hoechst's Hostaphan that have large Tensile Strength and Graves' Tear factor. Dupont's 48 gauge Mylar has a density of 16.85 g/m², a Tensile Strength of 186 Mpa and a Tear factor of 300 gram. Although the Tensile Strength of 48 gauge Mylar of 186 MKgf/m² is large enough to sustain the braking force of the droping parachute, the shroud may be reinforced with a net of fibers juxtaposed, glued or heat fused to the Mylar shroud, as illustrated in FIG. 2. For example as illustrated in FIG. 2, if a triangular net 21 of 750 (3×250), 3 mil (75μ) diameter Nylon fibers 11 of 180 m/gr density and 5 m long each, are used to cover the 20 m² shroud surface, it will add 20 grains only to the weight of the shroud. If the same number of “A” size Kevlar filaments of density of 40 m/g and tear strength of 3.6 kg are used to reinforce the shroud, the 750 filaments will weigh 90 g.

The ends of the fibers 11 overhanging over the periphery of the torus shaped tube may be joined into groups of strands 9 and used to sustain the jumper's harness. The torus-shaped tube may also be filled with hot air, to increase its buoyancy; in such a case the tube should be made of high-temperature withstanding polyimide film such as Dupont's Kapton that can withstand temperatures as high as 400° C. or Honeywell/Allied Signal's Capran that can withstand temperatures up to 400° F., and could be inflated by a hot air blower.

Thin polyethylene films although permeable to helium, are suitable for emergency parachutes that have a very limited use-time, of several minutes at most. When the inflatable parachute is for use in incendiary circumstances, the thin films used to fabricate the emergency parachute have to be non-flammable, for example using Honeywell/Allied Signal's ACLAR made primarily of chlorotrifluoroethylene (CTFE) or ASAHI GLASS' Fluon-ETFE films.

The size of the surface, the canopy projects on a surface orthogonal to its motion is what determines the braking force of the parachute. In our design this is the surface enclosed by the torus-shaped tube. Thus for example if the diameter of the torus is 5 meter, the surface it presents orthogonal to its falling direction is approximately 20 m², and the braking force equals F_{B}=0.1V²S=2V² Newton. Equating the braking force with the combined weights of the falling body and its parachute enables to calculate the velocity of the falling body when an equilibrium between these counteracting two forces is achieved. If for example we assume that the falling body and its parachute weigh 75 kg, then V=(75/2)^{½}=6.12 m/sec, meaning that as the braking force of the canopy increasingly counters the gravity, the jumper's acceleration decreases from 9.81 m/sec² at the moment of jumping to zero when the two forces are equal; during this time the falling velocity increases from zero to 6.12 m/sec, and stays the same from this moment and on, as the jumper continues his descent at the same velocity. As V=(2 gH)^{½} it follows that H=1.91 m, meaning that the velocity reached by the end of the decelaration equals that reached when dropping to the ground after jumping from a height of H=1.91 m. As in the above calculation the jumper is represented by his center of gravity and his feet being at least 60-80 cm below his center of gravity, this means that the impact with the ground is, in this case, like jumping from a wall 1.1-1.3 m high.

The volume of helium needed to lift the parachute in the air, may be calculated according to the Archimedes principle. As 1 liter of helium weighing 0.18 grams displaces 1 liter of air weighing 1.25 grams, it can lift up to 1.07 grams of additional weight per liter.

As shown in FIGS. 1 and 2, the plurality of light-weight fibers 11 overhanging from the shroud 1 and the torus shaped tube 5, are assembled into groups of thicker strands 9 and combined in a plastic receptacle 7, that sustains the harness 8. For example if the 750 Mylar fibers, 75μ thick, composing the triangular net (3×250) are grouped into 24 groups, each strand 9 will consist of 63 fibers, that when fused or weaved together will be approximately 0.6 mm thick; the 24 strands constituting the suspension lines will then be joined in the receptacle 7.

Alternatively, the fibers 11 reinforcing the shroud may end at the periphery of the shroud and the suspension lines 9 connecting the inflatable torus-shaped tube to the receptacle 7 may be attached to grommets 13 inserted onto triangular sheets of Mylar 12 glued or heat fused to the edge of the torus-shaped tube. For example 60 support lines of 7 mil diameter (175μ) Nylon strings with a density of 37 m/gram and a strength of 1.35 kg and a, will support a 75 Kg body. The load is distributed on a larger triangular sheet of Mylar of 10 cm base fused to the side of the torus-shaped Mylar tube as shown in 12 FIG. 1. The 60 suspension lines, each 7 m long, connecting the torus-shaped tube 5 to the receptacle 7, will weigh a total of ˜2.4 grams if made of Nylon.

Similarly 24 support lines of “A” size Kevlar filaments 9 with a density of 40 m/gram and a strength of 3.6 kg each, adhesively bonded to the 24 strands of fibers 11 overhanging from the periphery of the shroud, may support a 86 Kg load; if the 24 Kevlar support lines are 7 m long each, they will weigh a total of 4.2 grams.

The suspension lines 9 converge onto a central point situated at a given distance D below the center of the torus. They are glued or heat-fused together in a plastic receptacle 7 out of which come two cords 8. The two cords are attached to an harness 9 that supports the jumper.

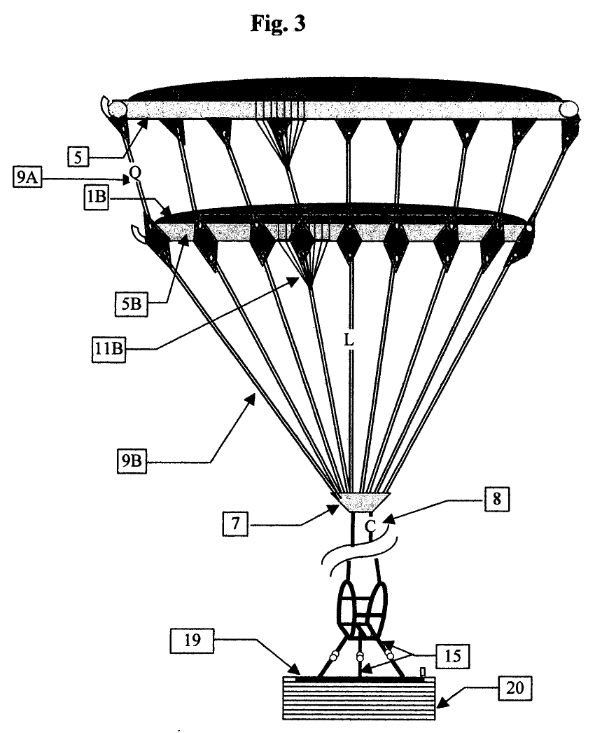

Similarly the torus shaped tube may be suspended from the spherical balloon using Nylon or Kevlar Strings 3 that are bonded in their middle to the inflatable sphere over half the circumference that goes over the “pole” of the sphere as shown in FIGS. 1 and 3. The ends of the strings are adhesively bonded to triangular sheets of Mylar which cover the periphery of the torus shaped tube and are also bonded to it; they serve to distribute the pull exerted by the strings over a larger surface. A total of 60 Nylon strings 24 each 10 m long with a density of 180 m/g weighs 3.3 g and the 120 triangular strips of Mylar each 5 cm long by 5 cm high will weigh a total of 2.6 g.

TABLE 2

| | Dimensions (m) | surface (m²) | weight (g) | He volume (m³) | | buoyancy (g) | |
|---|---|---|---|---|---|---|---|
| Sphere (He filled) | r = 0.5 m | 3.14 | 53 | 0.523 | | 560 | |
| Shroud | R = 2.5 m | 20 | 337 | | | | |
| Nylon Shroud support | 750 fibers 5 m | — | 20 | | | | |
| Torus (He or Air filled) | r = 0.05 m L = 15.7 m | 5 | 85 | 0.123 | (0*) | 132 | (0*) |
| 60 sphere support strings | L = 10 m each | | 3.3 | | | | |
| 120 Mylar strips | | | 2.6 | | | | |
| 24 Kevlar support lines | L = 7 m each | | 4 | | | | |
| 2 Harness Cords | L = 7 m each | | 12 | | | | |
| Total | — | | 517 | 0.646 | (0.523*) | 692 | (560*) |

*If the torus is air filled

Table 2 above summarizes the dimensions, weight and buoyancy of an emergency parachute consisting with flat-dome shaped canopy of 5 m diameter made of 48 gauge Mylar (16.85 g/m²) supported by a thin torus-shaped tube of 5 cm radius sustained by a spherical balloon of 1 m diameter.

Table 3 below summarizes the dimensions, weight and buoyancy of an emergency parachute based on a single Helium inflatable torus-shaped tube covered by a thin-film shroud.

TABLE 3

| | Dimensions | surface | weight | He volume | buoyancy |
|---|---|---|---|---|---|
| | (m) | (m²) | (g) | (m³) | (g) |
| Shroud | R = 2.5 m | 20 | 337 | | |
| Nylon Shroud support | 750 fibers 5 m each | — | 20 | | |
| Torus (He filled) | r = 0.11 m L = 15.7 m | 10.8 | 184 | 0.596 | 638 |
| 24 Kevlar support lines | L = 7 m each | | 4 | | |
| 2 Harness Cords | L = 7 m each | | 12 | | |
| Total | — | | 597 | 0.596 | 638 |

Compressed Helium cylinders are available commercially. For example a (20″×7″) canister (PY5803-1) weighing 9 lbs containing 24 cf (0.65 m³) of helium can be purchased commercially from West Winds, a commercial helium supplier from Westlake, Ohio. Smaller helium cannisters for filling party balloons are widely available.

The lower part of the harness 14 that the jumper wears before jumping, may be attached by three short detachable cords 15 of approximately 3 feet long each, to an optional air inflatable mattress 20. The optional mattress 20 is inflatable through a vent orifice 17; it is built out of several interconnected layers that reinforce the spring effect of the air when suddenly compressed. A lightweight rigid plate 19 made for example of light-weight composite material, is secured to the top of the air-mattress under the harness 14, where the jumper's feet rest, when the mattress hits the ground. The purpose of this plate is to distribute the weight of the jumper over a larger area when his feet hit the air mattress, immediately after the mattress impacts the ground. The optional mattress assembly may be attached to the harness by the jumper immediately before jumping and after the parachute assembly without the mattress has been inflated and released to rise in the air, thanks to its buoyancy.

FIG. 3 illustrates a double-decker parachute comprising two canopies 5 and 5B connected between them in series by a set of strings 9A. Table 4 below shows the dimensions, weight and buoyancy of such a a light-weight emergency parachute, whose buoyancy is supplied by two helium filled torus shaped tubes of 10 cm radius, each.

TABLE 4

| | | | weight | | He | | Buoyancy | |
|---|---|---|---|---|---|---|---|---|
| | Dimensions (m) | surface (m²) | (g) | | Volume | | (g) | |
| Torus I | r = 0.1 m L = 11.93 m | L × 2πr = 7.50 | 127 | | 0.374 | | 400 | |
| Shroud I | R₁ = 1.9 L = 2πR | πR₁² = 11.33 | 191 | | — | | — | |
| Shroud I support | 570 fibers 10 m each | | 32 | | | | | |
| Torus II | r = 0.1 m L = 10.44 m | L × 2πr = 6.6 | 111 | | 0.328 | | 350 | |
| Shroud II | R₂ = 1.7 L = 2πR | πR₂² = 9.07 | 153 | | | | | |
| Shroud II support | 510 fibers 4 m each | | 11 | | | | | |
| 120 Mylar strips | 12.5 cm² each | | 3 | | | | | |
| 24 Kevlar support lines | L = 7 m each | | 4 | | | | | |
| 2 Kevlar Harness Cords | L = 7 m each | | 12 | | | | | |
| Total | — | | 644 | g | 0.702 | m³ | 750 | g |

The main advantage gained by replacing a larger canopy by two smaller surfaced canopies of equal braking force, is the improved stability of the structure at the moment of jump.

The very first moment after the jump is critical as the combined center of gravity of the parachute and the jumper is very close to that of the jumper, as the parachute is lightweight and the mass of air under a single canopy is very small. In case the center of gravity is outside a virtual cylinder extending from the canopy to the ground, the parachute and the jumper will fall to the ground separately, the less than 1 kg parachute trailing the 75 kg jumper, the canopy unable to develop its braking force and decelerate the jumper's fall. In order for the canopy to start exerting its braking force immediately, it is essential for the jumper to jump to within the virtual cylinder 37 descending from the canopy and not just let himself slide over the sill of the window. It is therefore important to bring the deployed canopy and its center of gravity as close as possible to the jumper. A canopy supported by an elliptical torus, whose long axis is positioned parallel to the building and adjacent to it, facilitates the “landing” of the jumper closer to the center of the canopy, which being at the center of the short axis, is closer to the jumper. In addition, in a twin canopy emergency parachute, the air mass between the canopies, which in the example illustrated in table 4 weighs approximately 40 kg, contributes to shifting the center of gravity of the combined system, “jumper+parachute+air-mass”, upwards and towards the center of gravity, thus increasing the stability of the combined system.

Therefore for jumping from a window, the twin-canopy elliptical parachute is the preferred embodiment, while jumping from a roof, for example, the single circular canopy, sustained by a spherical helium inflated balloon, is simpler and the preferred embodiment.

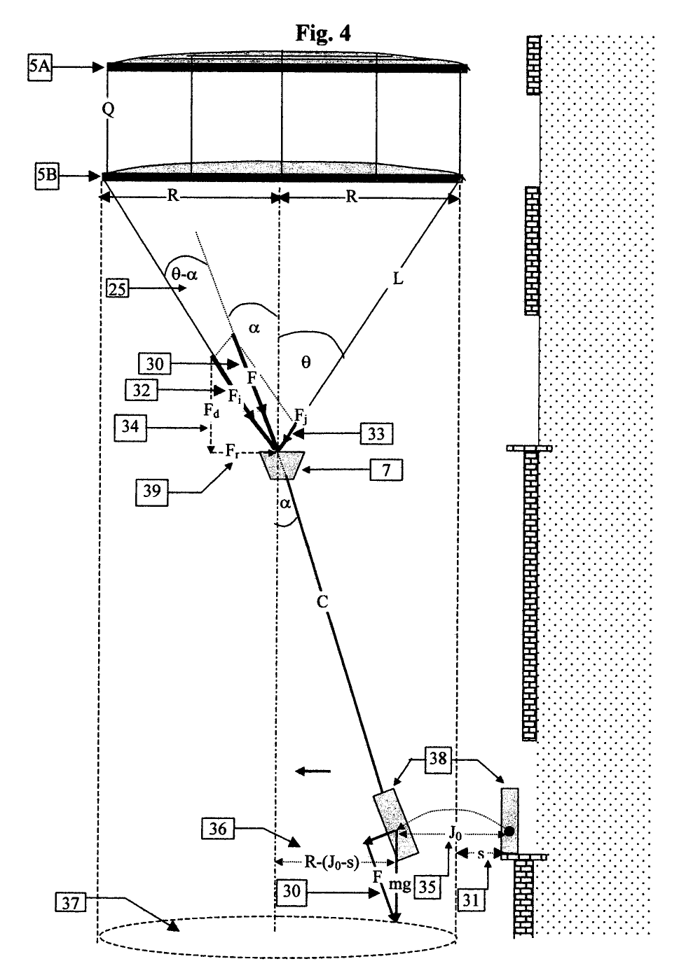

As shown in FIG. 4, the fully deployed canopy 5B may be at a distance (s) 31 from the wall of the building, from which the jumper is preparing to jump. The jumper 38 that has a weight mg ought to jump as far as he can, to an initial distance (J₀) 35 larger than (s), in order to be within the virtual cylinder 37 descending from the twin canopies. The force (F) 30 pulling the receptacle 7 at an angle α from the vertical, is given by F=mgcosα where sinα=[R−(J₀−s)]/C and R is the canopy's radius, and (C) is the length of the cords sustaining the harness. Obviously if we want to maximize from the very first moment the braking force of the canopies, F should be maximal or a minimal, which leads to the conclusion that C the length of the cords leading from the receptacle 7 to the harness should be as long as practicable. Other than trying to jump as far as possible, the initial α can also be minimized by decreasing the radius of the canopy R, which leads to the conclusion that it is preferable to have two smaller canopies rather than a large one and preferably have elliptical canopies with the short axis positioned towards the jumper. Thus for example an inflatable elliptical torus of short and long axes of 1.35 cm and 2.35 cm will have a surface of 10 m²; positioning the short axis at s=15 cm form the wall will position the center of gravity at 1.5 m from the jumper enabling almost every jumper to land at least in the middle of this distance, say at 75 cm from the center. If the Kevlar cords sustaining the Harness are 7 m long as indicated in Table 4, α≃sin α=75/700=0.107 radian ˜6°

The receptacle 7 serves to redistribute the pulling force F 30. In the absence of the receptacle 7 if the suspension lines were directly joined at the harness, at the moment of jump the suspension lines close to the jumper would sustain the entire load, while the suspension lines far from the jumper would experience little load; this strong imbalance would result in an immediate inclination of the light weight canopy and could result in tripping over of the parachute. The receptacle distributes the pulling force F 30 into several forces along the support lines Fᵢ 32, Fⱼ 33 that tend to stretch them; the support lines then exert on the canopy a downward pulling force F_{d} 34 that develops the desired countering braking force and a second set of forces Fᵣ 39 along the radii of the canopy that tend to squeeze the torus shaped tube. To maximize the component pulling the canopy down and minimize the component squeezing the canopy the angle θ (sinθ=R/L) ought to be minimized, leading to the conclusion that the radius of the canopy ought to be minimized and the length L of the support lines maximized. However for any given α a more symmetric redistribution of the original pulling force F 30 between the support lines requires maximizing θ. If θ=30° so that L=2R, the component pulling down the canopy is still 86% of the force F pulling the receptacle; while if L=4R as is the case in the example illustrated in Table 4 the component pulling down the canopy is 98% of the force pulling the receptacle.

In the case of a twin canopy presenting a combined 20 m² surface, the braking force is F_{B}=2V² Newton countered by the falling body's weight (gravitational force). To minimize the time until the torus-shaped parachute starts exerting its braking force, it is necessary that the strings attaching the jumper to the parachute be fully stretched before taking the leap, so that when the jumper's descent starts, the canopy may immediately start exerting its braking force. This condition may be achieved if the jumper, instead of letting himself fall towards the ground, first releases the strings he is holding in his hands and lets them stretch by the rising canopies due to their buoyancy and then jumps upwards and towards the center of the canopy. In this case, during the split second that the jumper moves upwards, the canopy continues to rise and further stretches the cords. When the jumper, after the split second, starts its fall, its speed accelerates concurrently with the increase of the braking force of the canopy, so that by the time the jumper reaches the impact velocity given by V_{f}=[mg/(2)]^{½} the canopy offsets exactly the force of gravity, so that the jumper continues to fall at this constant velocity V_{f}.

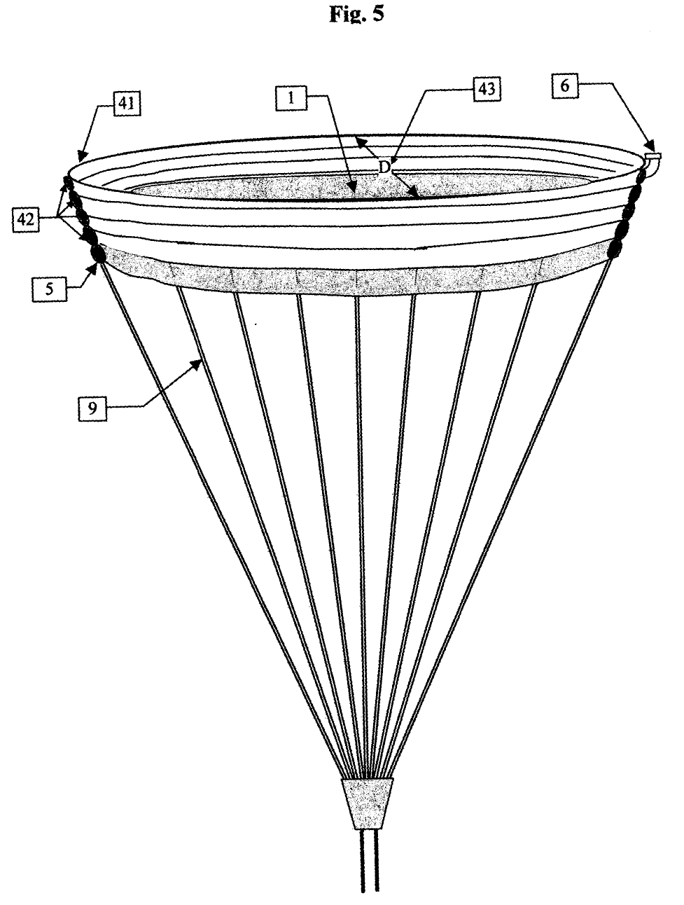

FIG. 5 illustrates the shroud of the canopy surrounded by a thin skirt 41 formed by an inclined inflatable protrusion stemming from the side of the torus-shaped annular tube 5, communicating with and inflatable through a venting tube 6. To preserve an elongated form the inverted skirt is composed of several smaller torus-shaped tubes 42, laid one of the top of the other, each tube having an outer diameter 43 slightly larger than the tube beneath it. To facilitate the inflation of the skirt, the torus-shaped tubes 42 may be interconnected at several points between them and the main torus shaped tube 5. Inflating them with a lighter-than-air gas, such as helium, adds buoyancy to the structure and causes it to rise in the air. The role of the inverted skirt 3 is to add additional lift to the parachute when dropping downwards. The air flowing upwards, by the main torus-shaped annular tube, is deflected upwards by the skirt thus reducing the air pressure on the top of the shroud 1. This aerodynamic structure adds additional lift to the canopy. A 48 gauge Mylar skirt made of 4 torus shaped tubes of 2.5 cm diameter each and a length of 10.6 m to cover the periphery of a shroud of 1.7 m diameter will weigh 56 g. The number of tubes 42 and their dimensions is determined experimentally balancing their weight versus the additional lift they provide.

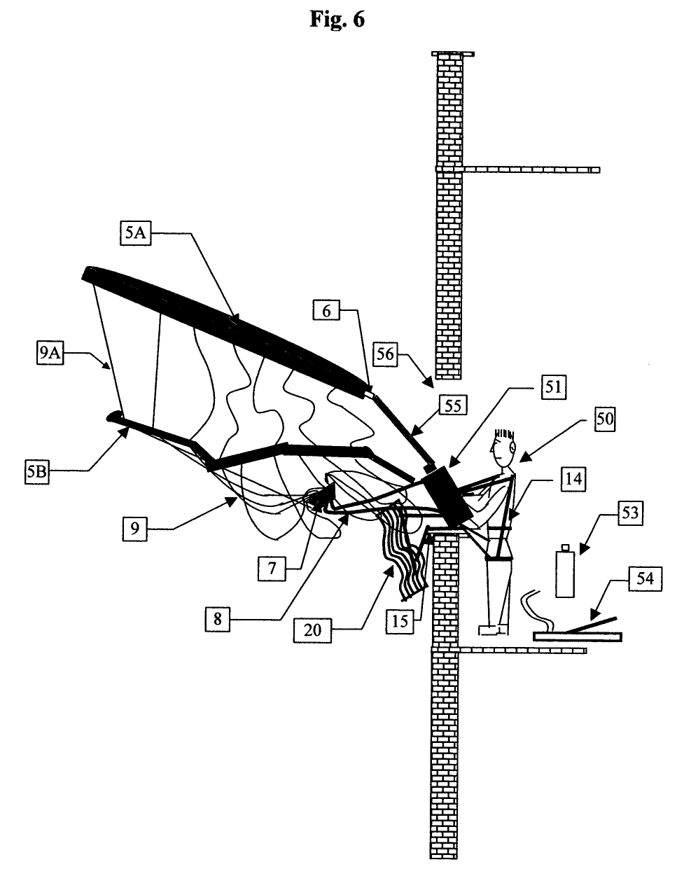

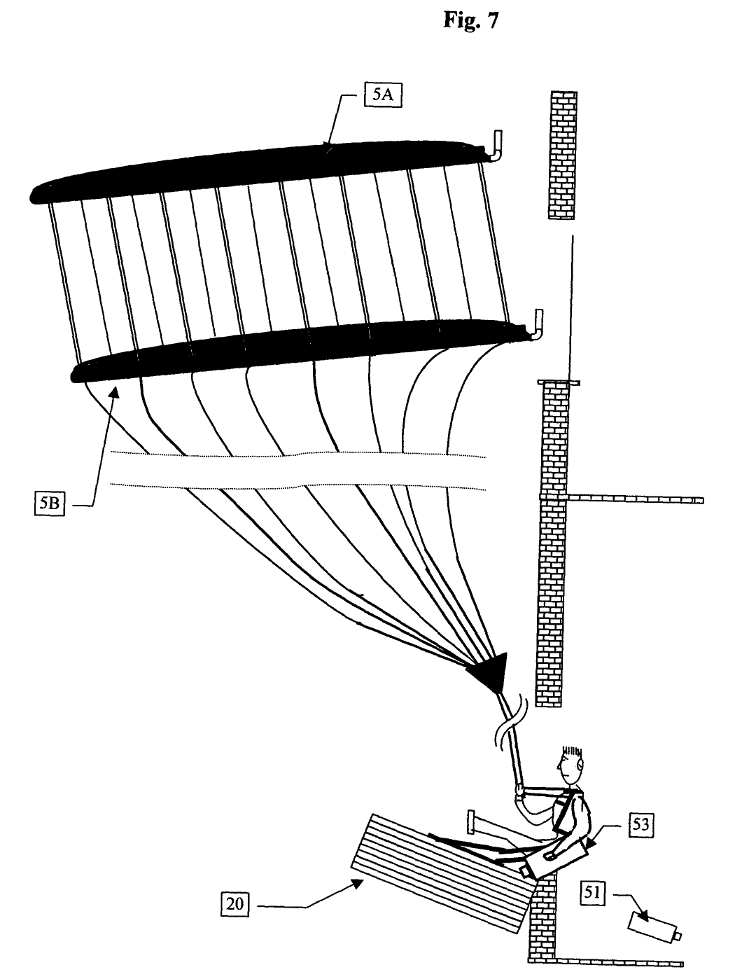

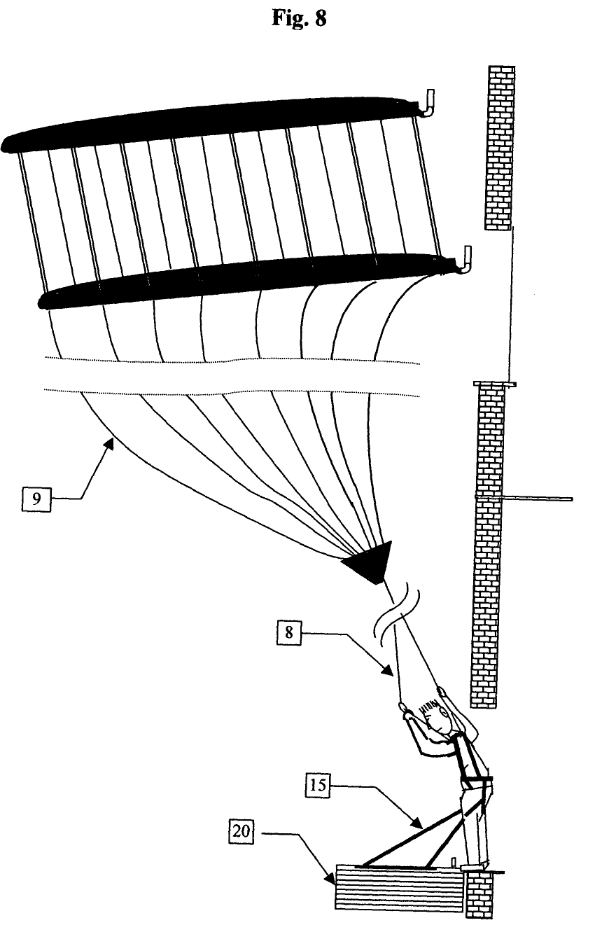

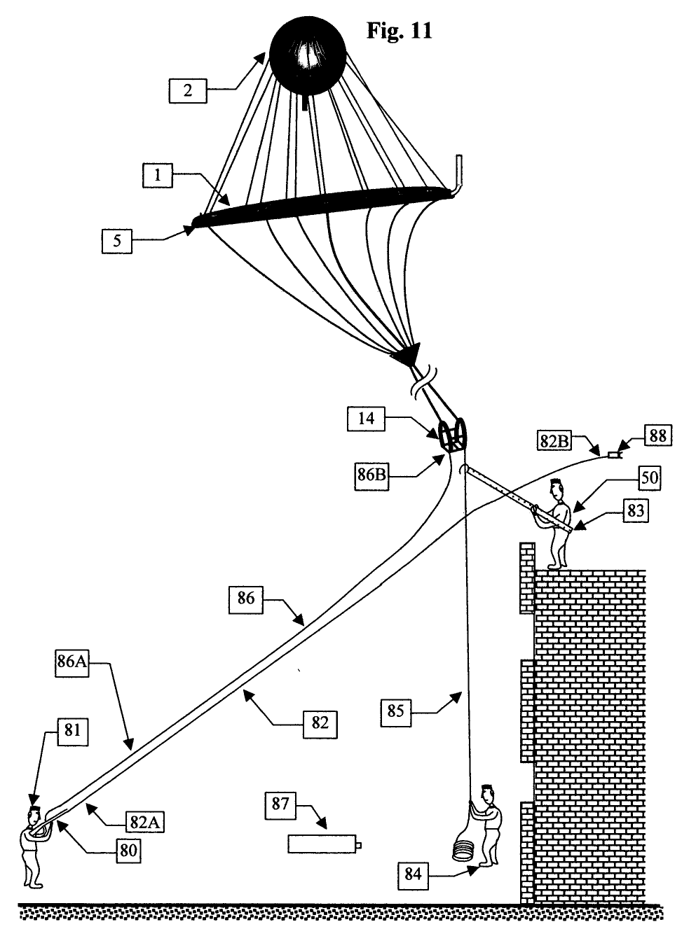

FIGS. 6, 7 and 8 illustrate the preferred method of jumping from a window of a building 56 with a twin-canopy emergency parachute, although the same method is applicable in principle to jumping from the roof or from any elevated place above ground and/or with other embodiments of the emergency parachute inflatable with lighter-than-air gas described above, with some self-evident modifications. As illustrated in FIG. 6, the jumper 50 first secures the harness 14 to his body and throws overboard the non-inflated air mattress 20 attached with very short cords 15 to his harness. He first inflates the upper torus-shaped tube sustaining the canopy 5A, or the spherical balloon if the emergency parachute consists of an helium inflated balloon sustaining a canopy, by securing one end an elongated inflation tube 55 to the inflation vent 6 of the canopy and the second end to a compressed helium container 51, and then opening its gas release valve. After the upper canopy 5A is helium inflated, the jumper releases it into the air, and starts inflating the second torus-shaped tube sustaining the second canopy 5B. If the emergency parachute is composed of an inflatable spherical ballon sustaining a canopy and the buoyancy of the spherical balloon is sufficiently large, the torus shaped annular tube of the canopy may be air inflated using the compressed air container 53 or an air-pump 54 that may be electrical or foot actuated. Obviously the torus shaped annular tube may also be helium inflated if the availability of helium is not a problem, as the case may be if the parachute is first deployed on ground and then floated to the potential jumper as illustrated in FIG. 11. The second torus-shaped annular tube 5B covered by the shroud is sustained by the suspension lines 9A attached to the first canopy 5A; it is also attached by the suspension lines 9 to the receptacle 7 which is connected to the cords 8 that attach to the jumper's harness 14. When the torus-shaped tube is partially inflated so that it can still pass through the window, the jumper throws it out of the window together with the attached suspension lines 9, the receptacle 7 and the cords 8, and proceeds to finish the inflation of the torus-shaped tube completely. He then sits on the sill of the window's frame as shown in FIG. 7 and inflates the air-mattress 20 attached to his harness with the compressed air balloon 53. At this stage he also releases the cords 8 and the canopy rises to its maximal height, powered by the buoyancy of the twin canopies, stretching the cords 8 attached to the harness to their maximal extent. When the air mattress is fully inflated he stands as shown in FIG. 8, slightly stooped, on the sill of the window's frame, pulls the cords 8 to generate an upwards inflation of the shrouds, and jumps upwards and as far as he can, towards the center of the parachute, in the process releasing the cords in order to cause the maximal reaction of the canopy, as explained in conjunction with FIG. 4. Immediately after jumping, the air mattress 20 attached to the jumper's harness with short cords 15 approximately 2-3 feet long, floats under the jumper's feet due to the symmetrical attachment of the short cords and “sticks” to the jumper's shoe's due to the air resistance caused by its large surface.

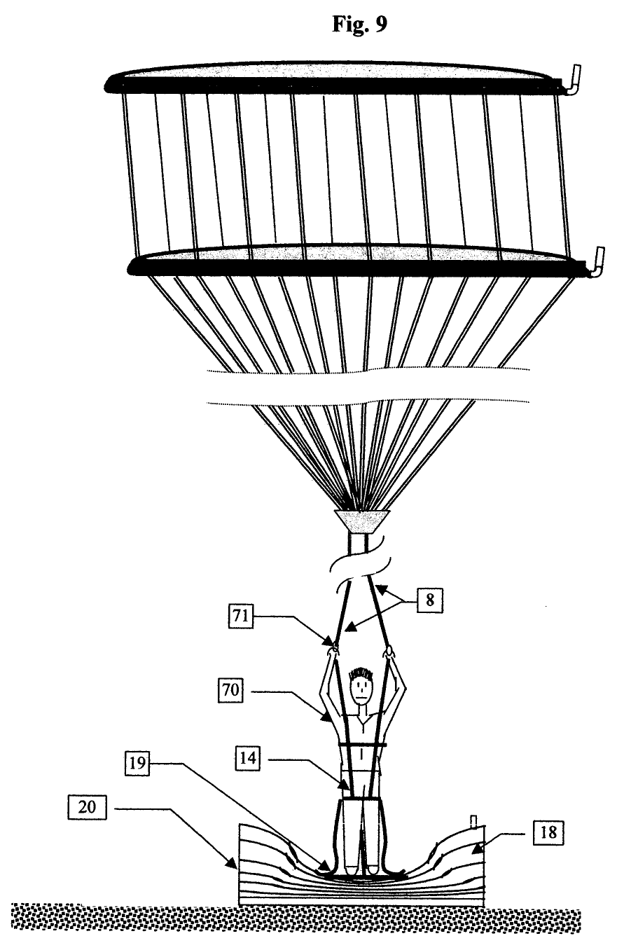

FIG. 9 illustrates the landing of the jumper on the ground immediately after the jumper's feet hit the rigid plate 19 secured to the top of the mattress 20, for the purpose of distributing the impact over a larger surface. The kinetic energy of the jumper (m/2)V_{f}² is absorbed by the rigid plate 19 which transfers it to the air mattress 20 which acts as a gradually contracting spring and thus slows the impact with the ground. A cubical air mattress having the dimensions of 0.4 m on each side and divided into 5 horizontal sections 18, has a surface of 2.5 m² and if built of Mylar having a density of 17 g/m², will weigh 42 grams a 0.5 m×0.5 m rigid composite plate will weigh The addition of an air mattress able to absorb part of the impact, enables to allow a larger velocity of impact with the ground and consequently reduce the surface of the canopy generating the braking force.

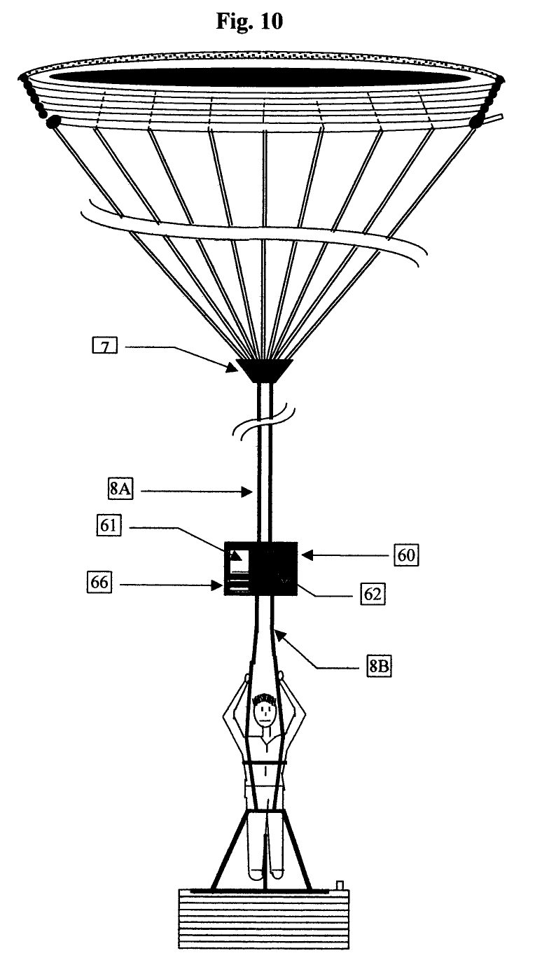

FIG. 10 illustrates an additional way to increase the braking force F_{B} of the canopy by pulling it down relative to the jumper and thus increasing its velocity. This can be achieved by a high torque, reel that operates for a short time (Tᵣ) of then order of a second or two, until the jumper hits the ground and rewinds the cords 8 at a speed of (Y) m/sec, thus adding to the canopy a braking force of Fᵣ=(0.1SY²) for a (Tᵣ) sec. In principle the energy stored in the reel is transformed into a braking force applied along a small distance until said energy is consumed and the reel stops rewinding. For example to shorten the distance between the jumper and the canopy weighing together 75 kg for 1 m, requires W=75Joule=75Watt-second of energy which several high-Farad (up to 50F) aerogel supercapacitors, available for example from Cooper Electronic Technologies can discharge instantly onto a high torque DC motor, available for example from Poly-Scientific, for one second, causing the distance between the jumper and the parachute to shorten at a velocity of 1 m/sec exerting a braking force on the 20 m² canopy of Fᵣ=(0.1SY²)=1.8 Newton. If the canopy is designed to limit the impact velocity to 6.12 m/sec as illustrated above, reducing this impact velocity by 1 m/sec to 5.12 m/sec will reduce the impact from an equivalent jump from a 1.91 m high wall to a jump from an 1.34 m high one, which is a significant improvement.

A box 60 containing a set of high capacitance capacitors 66, a DC motor 61 and a one-way reel 62 is suspended from the receptacle 7, the cords 8A wound on the reel 62. The jumper hangs from cords 8B connected to the box 60. Thus, several high capacitance capacitors may be charged by a battery with a quick discharge capacity during several minutes before the jumper readies to jump. The jumper jumps with the box 60 and immediately activates an electrical connection that discharges the capacitors to the electrical DC motor, that quickly starts rewinding the cords 8A for 1-2 seconds and shortens the distance between the jumper and the receptacle 7. FIG. 11 illustrates an alternative method of using the pre-deployable emergency parachute by inflating and deploying it on the ground and “sending” it to the potential jumper in need of the parachute. In this alternative method, the buoyancy contributing elements, the spherical balloon 2 and the torus-shaped circular or elliptical tube 5 supporting the shroud 1, in this case, are inflated on the ground using a compressed helium cylinder 87. The parachute is let to rise, adjacent to the structure the prospective jumper 50 is on, held by a person 84 on the ground, until the harness 14 reaches the height from which the jumper 50 can retrieve it, using for example a long stick 83 at the end of which is a hook, or another improvised tool.

Alternatively, using an airgun 80, a projectile 88 from which uncoils a string 82, whose one end 82A stays attached to the airgun, can be “shot” in a trajectory aimed towards the place where the jumper 50 is standing. Once the prospective jumper 50 collects the projectile 88 and gets hold of the end 82B of the string threading from the projectile, the other end 82A of the string is tied to the end 86A of the string 86 whose other end 86B is attached to the harness 14, and is released to enable the jumper 50 to retrieve the harness 14 and the attached parachute. Several attempts may be made, to send a string to the prospective jumper, using different projectiles, depending on the nature of the structure the prospective jumper is standing on.

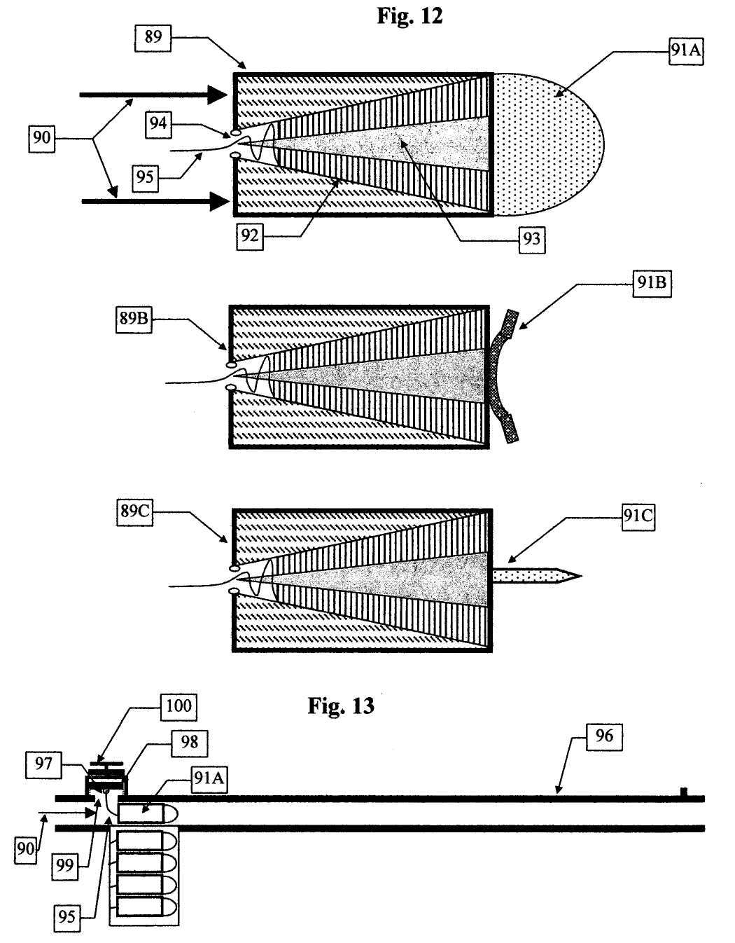

FIG. 12 shows several embodiments of projectiles that may be shot by an air or compressed-gas gun, for establishing a physical link, in the form of a thin thread or flexible wire, with a remote target.

Projectiles 89, 89B and 89C are propelled by the pressure of the gas 90 inside the gun barrel, and contain an ultralight string 92, of Mylar fiber for example, wound around a conical support 93, whose one end 95 protrudes through an orifice 94 on the back of the projectile. The front end 91A of projectile 89 is aerodynamically curved. The front end of projectile 89B illustrates an elastic semi-circular front end 91B that upon impact with a flat surface, collapses into a flat shape and adheres to a flat surface due to the air pressure on its back. The fron end 91C of projectile 89C illustrates a sharp nail-like front end, suitable penetrating a wooden surface.

The barrel of an air or compressed-gas gun has to be modified, so as to allow the string 95 protruding from an orifice at the end of the projectile 89, to be secured to the gun, without diminishing the gas or air pressure 90 that propels the projectile. FIG. 13 illustrates such a modification of the barrel 96 of a compressed-gas gun. The thread 95 protruding from an orifice 94 at the end of the projectile is retracted through an opening 99 on the barrel situated immediately behind the projectile and tied to a ring 97 situated on a plug 98, that when pressed against the wall of the barrel, by a vise-like press 100, hermetically closes the opening 99.

Obviously there are several ways to implement the invention of the inflatable emergency parachute described exemplarily in conjunction with FIGS. 1 through 13, and using materials other than those mentioned above as a way of example, without departing from the scope and intent of the present invention. Those skilled in the art will recognize that other configurations and ways of implementing the invention are possible. It will thus be seen that the invention efficiently attains the objects set forth above, namely the ability to jump from any altitude with tolerable bodily impact. It is understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

1. An ultralight parachute enabling to jump with, from any altitude and still hit the ground with tolerable impact, comprising a number of distinct and separate inflatables joined by flexible thin threads, such inflatables being either spherical or torus-shaped where the central outer hole of the torus is covered by a flat thin shroud bonded, fused or adhesively joined to it, whereas the aggregate buoyancy in the air of such inflatables, when fully inflated with lighter-than-surrounding-air gas through a conduit, from a vessel situated outside the parachute and containing said lighter-than-surrounding-air gas, will exceed the total weight of the parachute and will cause it to rise to a height above the potential jumper or the attachable load, and whereas when said inflatables are drawn towards the ground by the weight of the load or the jumper suddenly added to them, their aggregate total surface projected in the direction of the motion will be such that the aerodynamic countering force engendered by their motion in the air, will equal or surpass the weight of the load or the jumper and decelerate their motion, such parachute also comprising load carrying means including straps and harnesses, such load carrying means attached to said inflatables by lightweight flexible attachment means including threads, ribbons, cords, or fibers.

2. An ultralight parachute as set forth in claim 1 where the number of inflatables is one torus-shaped tube and the shroud covering its outer central hole is made of a material consisting of a lightweight thin film bonded, heat fused or adhesively joined to a net of ultrastrong light-weight fibers, whereas such fibers extending substantially beyond the periphery of the torus-shaped tube are first aggregated into a multiplicity of bundles of strands symmetrically positioned around the periphery of the torus-shaped tube and thereafter joined together in a receptacle situated symetrically at a distance from the center of the torus-shaped tube, and whereas suspension lines attached to said receptacle, hold a harness worn by the jumper.

3. An ultralight parachute as set forth in claim 2 whereas the multiplicity of bundles of strands are joined together in a receptacle situated symmetrically at a distance from the center of the torus-shaped tube of approximately the outer diameter of the torus-shaped tube, and whereas suspension lines of approximately the length of the large diameter of the torus-shaped tube attached to said receptacle, hold a harness worn by the jumper.

4. An ultralight parachute as set forth in claim 3 where the inflatable torus-shaped tube is elliptical, and whereas the long axis of the elliptical torus-shaped tube is positioned parallel to the wall of the building from the window of which the jumper prepares to jump

5. An ultralight parachute as set forth in claim I where the number of inflatables are two torus-shaped tubes, positioned one on top of the other, where the shrouds covering their respective outer central holes are made of a material consisting of a lightweight thin film bonded, heat fused or adhesively joined to a net of ultrastrong light-weight fibers, such fibers extending substantially beyond the peripheries of the torus-shaped tubes and whereas the torus-shaped tube at the bottom is sustained by the fibers extending from the periphery of the top torus-shaped tube, and are bonded, heat fused or adhesively joined symmetrically to its periphery, and whereas the ends of the ultrastrong fibers extending substantially from the periphery of the second torus-shaped tube at the bottom, are first aggregated into a multiplicity of bundles of strands symmetrically positioned around the periphery of the torus-shaped tube and thereafter joined together in a receptacle situated symetrically at a distance from the center of the torus-shaped tube, and whereas suspension lines attached to said receptacle, hold a harness worn by the jumper

6. An ultralight parachute as set forth in claim 4, whereas the distance between the bottom torus-shaped tube and the top torus-shaped tube determined by the length of the fibers sustaining it is approximately equal to the outer diameter of the torus-shaped tube and whereas the receptacle where the multiplicity of bundles of strands are joined together is situated symmetrically at a distance from the center of the torus-shaped tube of approximately the outer diameter of the torus-shaped tube and whereas the suspension lines holding the harness worn by the jumper are of approximately the length of the outer diameter of the torus-shaped tube,

7. An ultralight parachute as set forth in claim 6 where the number of inflatables are two elliptical torus-shaped tubes, whereas the long axis of the elliptical torus-shaped tubes are positioned parallel to the wall of the building from the window of which the jumper prepares to jump,

8. An ultralight parachute as set forth in claim 1 where the inflatables consist of one spherical balloon and one torus-shaped tube joined by a multiplicity of symmetrically distributed ultrastrong light-weight fibers of substantial length, bonded or adhesively joined at their middle section to part of the upper hemisphere of the spherical balloon in a path traversing its pole, while the ends of the fibers extending beyond the spherical balloon are attached, bonded or adhesively joined, in a symetrical distribution to the periphery of the torus-shaped tube, and whereas the shroud covering the outer central hole of the torus shaped tube is made of a material consisting of a lightweight thin film bonded, heat fused or adhesively joined to a net of ultrastrong light-weight fibers, whereas such fibers extending substantially beyond the periphery of the torus-shaped tube are first aggregated into a multiplicity of bundles of strands symmetrically positioned around the periphery of the torus-shaped tube and thereafter joined together in a receptacle situated symetrically at a distance from the center of the torus-shaped tube, and whereas suspension lines attached to said receptacle, hold a harness worn by the jumper.

9. An ultralight Parachute as set forth in claim 6 where the distance between the torus shaped tube and the spherical balloon sustaining it, equals approximately the diameter of the torus-shaped tube and whereas the receptacle where the multiplicity of bundles of strands are joined together is situated symmetrically at a distance from the center of the torus-shaped tube of approximately the outer diameter of the torus-shaped tube and whereas the suspension lines holding the harness worn by the jumper are of approximately the length of the outer diameter of the torus-shaped tube,

10. An ultralight parachute as set forth in claim 9 where the torus-shaped tube has an elliptical shape, and whereas the long axis of the elliptical torus-shaped tube is positioned parallel to the wall of the building from the window of which the jumper prepares to jump

11. An ultralight parachute as set forth in claim 2, wherein the torus-shaped tube has an inflatable skirt pointing upwards in the opposite direction of the envisaged motion and sideways, away from the torus-shaped tube, bonded or adhesively joined to its periphery, said skirt built by superimposing a multiplicity of circular tubular rings interconnected and adhesively stacked one on top of the other, where the outer diameter of the ring increases while the inner diameter of the tube decreases from one ring to the one above it, resulting in a circular structure with a relatively wide base and narrow top.

12. An ultralight parachute as set forth in claim 6, wherein the torus-shaped tubes have inflatable skirts pointing upwards in the opposite direction of the envisaged motion and sideways, away from the torus-shaped tubes, bonded or adhesively joined to their periphery, said skirts built by superimposing a multiplicity of circular tubular rings interconnected and adhesively stacked one on top of the other, where the outer diameter of the ring increases while the inner diameter of the tube decreases from one ring to the one above it, resulting in a circular structure with a relatively wide base and narrow top.

13. An ultralight parachute as set forth in claim 1 wherein the parachute comprises an inflatable air mattress, consisting of a multiplicity of separate horizontal layers, interconnected and inflatable together, said air mattress having a rigid light-weight top attached or adhesively bonded to it and attached to the load carrying means by cords approximately 2-3 feet long,

14. An ultralight parachute as set forth in claim 1 where the fall of the jumper or the load attached to load carrying means may be braked by inserting between the attachment means attached to the load carrying means and the attachment means connected to the inflatables, a high torque electro-mechanical reel that may be activated simultaneously with the jump or release of the load in the air, causing the immediate rewinding of the attachment means on the reel and in the process shortens the distance between the jumper and the canopy of the parachute, such electro-mechanical reel rotated by a DC motor powered by the instantaneous discharge of a stack of previously charged high capacitance capacitors.

15. An ultralight parachute as set forth in claim I wherein the distance traversed by the body sustained by the parachute, until its acceleration is nullified, is less than 2 meters.

16. An ultralight parachute as set forth in claim 1 wherein the inflatable parts and the shrouds are made of ultralight thin films so that its total weight is less than 0.7 kg while its inflatable parts have a volume greater than 0.7 m³.

17. A method for supplying an ultralight parachute of a construction as set forth in claim 1, to a person situated at an elevated floor, consisting of fully deploying the inflatable parachute on the ground, through a conduit, from a vessel containing lighter-than-surrounding-air gas situated outside the parachute, using means to direct and deliver the fully deployed parachute lifted by the buoyancy of its inflatable parts, to the person situated at an elevated floor

18. A method for supplying an inflatable parachute to a person situated at an elevated floor consisting of fully deploying the inflatable parachute on the ground, by inflating it with lighter-than-surrounding-air gas with through a conduit, from a vessel containing lighter-than-surrounding-air gas situated outside the parachute, and sending one end of a lightweight thread to a place in close proximity of the person in need of the parachute, thus enabling him to get hold of the thread, by shooting towards such a place, using an air or pressured gas gun, a pellet from the bottom of which unwinds said thread continually during its flight, and attaching the other end of the thread hitherto secured to the gun, to the deployed parachute on the ground, and let the parachute rise, whereas the person in need of the parachute can by pulling the thread attached to the rising parachute bring it to his close proximity enabling him to make use of it.
